(19) United States
(12) Patent Application Publication
(10) Pub. No.: US 2024/0095679 A1
(43) Pub. Date: Mar. 21, 2024

(54) VIRTUAL INTERVIEW SYSTEM USING MACHINE LEARNING MODELS

(71) Applicant: Capital One Services, LLC, McLean, VA (US)

(72) Inventors: Matthew NOWAK, Midlothian, VA (US); Mohamed SECK, Aubrey, TX (US); Louis BUELL, Chevy Chase, MD (US)

(21) Appl. No.: 17/933,258

(22) Filed: Sep. 19, 2022

(51) Int. Cl. G06Q 10/10

(52) U.S. Cl. CPC G06Q 10/1053

(57) ABSTRACT

In some implementations described herein, a system may receive resume data associated with a resume of a candidate. The system may identify, from the resume data, one or more resume attributes. The system may determine interview questions based on the resume attribute(s). The system may transmit, to an interview device, the interview questions. An interview question may be transmitted after receiving a response to a preceding interview question. The system may receive, from the interview device, response data corresponding to responses to the interview questions. For a particular response, the response data may include a video feed from the interview device of the candidate providing the particular response. The system may identify, from the response data, one or more response attributes. The system may determine, based on the response attribute(s) and historical response data associated with historical responses, a recommendation associated with the candidate.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

### SUMMARY

Some implementations described herein relate to a system for providing a virtual interview using machine learning models. The system may include one or more memories and one or more processors communicatively coupled to the one or more memories. The one or more processors may be configured to receive, from a user device of a user, resume data corresponding to a resume of the user. The one or more processors may be configured to provide the resume data as input to a first machine learning model. The first machine learning model may use a natural language processing (NLP) technique to identify a combination of resume attributes, from a plurality of resume attribute options, associated with the resume data. The one or more processors may be configured to receive, as output from the first machine learning model, a set of interview questions, from a plurality of interview question options, associated with the combination of resume attributes. The one or more processors may be configured to transmit, to a kiosk device, a first question of the set of interview questions. The one or more processors may be configured to receive, from the kiosk device, response data corresponding to a response to the first question. The one or more processors may be configured to transmit, to the kiosk device and based on receiving response data corresponding to a response to a previous question of the plurality of interview questions, a subsequent question of the set of interview questions. The one or more processors may be configured to receive, from the kiosk device, response data corresponding to a response to the subsequent question. For a particular response, the response data may include a video feed, from the kiosk device, of the user providing the particular response. The one or more processors may be configured to provide the response data as input to a second machine learning model. The second machine learning model may identify a combination of response attributes, from a plurality of response attribute options, associated with the response data. The second machine learning model may be trained based on historical response data associated with historical responses. The one or more processors may be configured to receive, as output from the machine learning model, a hiring score corresponding to the combination of response attributes. The one or more processors may be configured to determine, based on the hiring score, a hiring recommendation. A positive hiring recommendation may correspond to a hiring score that satisfies a hiring score threshold, and a negative hiring recommendation may correspond to a hiring score that fails to satisfy the hiring score threshold.

Some implementations described herein relate to a method of providing a virtual interview. The method may include receiving, by a system having one or more processors, resume data associated with a resume of a candidate. The method may include identifying, by the system and from the resume data, one or more resume attributes. The method may include determining, by the system and based on the one or more resume attributes, a plurality of interview questions. The method may include transmitting, by the system and to an interview device, the plurality of interview questions, wherein an interview question, of the plurality of interview questions, may be transmitted after receiving a response to a preceding interview question of the plurality of interview questions. The method may include receiving, by the system and from the interview device, response data corresponding to a plurality of responses to the plurality of interview questions, wherein, for a particular response of the plurality of responses, the response data may include a video feed, from the interview device, of the candidate providing the particular response. The method may include identifying, by the system and from the response data, one or more response attributes. The method may include determining, by the system and based on the one or more response attributes and based on historical response data associated with historical responses, a recommendation associated with the candidate.

Some implementations described herein relate to a non-transitory computer-readable medium that stores a set of instructions for a device. The set of instructions, when executed by one or more processors of the device, may cause the device to receive, from a user device of a user, resume data corresponding to a resume of the user. The set of instructions, when executed by one or more processors of the device, may cause the device to identify, from the resume data, one or more resume attributes. The set of instructions, when executed by one or more processors of the device, may cause the device to determine, based on the one or more resume attributes, a plurality of interview questions. The set of instructions, when executed by one or more processors of the device, may cause the device to transmit, to an interview device, the plurality of interview questions. An interview question, of the plurality of interview questions, may be transmitted after receiving a response to a preceding interview question of the plurality of interview questions. The set of instructions, when executed by one or more processors of the device, may cause the device to receive, from the interview device, response data corresponding to a plurality of responses to the plurality of interview questions. For a particular response of the plurality of responses, the response data may include a video feed, from the interview device, of the user providing the particular response. The set of instructions, when executed by one or more processors of the device, may cause the device to receive, from the interview device, response data corresponding to a plurality of responses to the plurality of interview questions. The set of instructions, when executed by one or more processors of the device, may cause the device to identify, from the response data, one or more response attributes. The set of instructions, when executed by one or more processors of the device, may cause the device to determine, based on the one or more response attributes, an interview score. The set of instructions, when executed by one or more processors of the device, may cause the device to determine, based on the interview score, a recommendation associated with the user. A positive recommendation may correspond to an interview score that satisfies an interview score threshold, and a negative recommendation may correspond to an interview score that fails to satisfy the interview score threshold.

### BRIEF DESCRIPTION OF THE DRAWINGS

FIGS. 1A-1C are diagrams of an example associated with a virtual interview system, in accordance with some embodiments of the present disclosure.

FIG. 2 is a diagram illustrating an example of training and using a machine learning model in connection with a virtual interview system, in accordance with some embodiments of the present disclosure.

FIG. 3 is a diagram illustrating an example of training and using a machine learning model in connection with a virtual interview system, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of a device associated with a virtual interview system, in accordance with some embodiments of the present disclosure.

FIG. 6 is a flowchart of an example process associated with a virtual interview system, in accordance with some embodiments of the present disclosure.

### DETAILED DESCRIPTION

The following detailed description of example implementations refers to the accompanying drawings. The same reference numbers in different drawings may identify the same or similar elements.

Some interviews (e.g., for a job or admission into a school) between a candidate and an interviewing entity may be conducted by a system in which a computerized entity or device may present, to the candidate, a set of preset interview questions. Such interview questions may be generic (e.g., the same for all candidates) and/or related to the particular position to which the candidate is applying, but not tailored to the candidate (e.g., based on information provided by the candidate prior to the interview, such as the candidate's resume). For example, the interview questions may be derived from a crude, inflexible formula that may limit or prevent the system's ability to adapt the interview questions to the candidate's personalized information, which may differ across all the candidates.

It may be difficult for the system to identify a particular candidate's relevant attributes (e.g., personal experiences and/or qualifications) from which the system may utilize in a meaningful manner to determine more personalized interview questions to ask the candidate. For example, a candidate's resume may include a lot of relevant and non-relevant information (e.g., words) that the system would need to process and analyze to extract such attributes. Additionally, different resumes may have different formats and/or may phrase similar items in different ways, thereby increasing the difficulty in identifying the attributes from the information. Furthermore, the possible attributes that the system may identify from the information, and therefore, the number of possible combinations of attributes, may be numerous (e.g., numbering in the thousands, millions, billions, etc.), which may make processing the information and/or the attributes to identify interview questions corresponding to a particular combination more challenging.

In addition, it may be difficult for the system to identify, from the candidate's responses to the more personalized interview questions, relevant attributes (e.g., content of the responses and/or behavioral characteristics of the candidate in providing the responses) that the system may utilize in a meaningful manner to determine a recommendation with respect to the candidate's candidacy. For example, each interview question may have numerous (e.g., endless) possible responses, and each response may include a lot of relevant and non-relevant information that the system would need to process and analyze to extract such attributes. Additionally, each response may have numerous (e.g., endless) possible attributes that may be associated with the response. Accordingly, the number of possible combinations of attributes also may be numerous (e.g., numbering in the thousands, millions, billions, etc.), which may make processing a particular combination of attributes to determine a recommendation challenging.

The limitations related to the system's difficulties in processing resumes and/or responses to interview questions may stem from limitations in the system itself (e.g., components of the system). For example, the system may not have the processing capability to process the numerous combinations of attributes associated with the candidate resumes and/or candidate responses. Additionally, or alternatively, the system may not have the language processing capability to identify certain attributes to a fine degree to obtain the number of attributes that may allow for more personalized interview questions and/or analysis of the responses to the interview questions. Additionally, or alternatively, the system may lack the fidelity (e.g., due to a lack of bandwidth and/or hardware limitations) to capture and transmit minor body language movements and/or nonverbal cues that may be identified as attributes.

Some implementations described herein relate to a virtual interview system that may present, in an automated interview, personalized interview questions to a candidate, and that may determine a recommendation based on the candidate's responses to those interview questions. The virtual interview system may automatically identify, from a resume of the candidate, a combination of resume attributes in a number of categories (e.g., syntax, grammar, education, skills, experience, job history, job roles, honors, awards, and/or interests). Based on the particular combination of resume attributes, the virtual interview system may identify a set of interview questions (e.g., from a large library of possible interview questions) tailored to the candidate and the combination of resume attributes. The virtual interview system may identify, from real-time responses by the candidate (e.g., obtained from a video feed and/or audio feed), a combination of response attributes in a number of categories (e.g., syntax, grammar, and/or behavioral characteristics, such as body language, talking speed, and/or eye contact) associated with the candidate. Based on the response attributes and historical interview data associated with the same or similar response attributes, the virtual interview system may determine a recommendation with respect to the candidate (e.g., whether or not to hire the candidate or move the candidate on to a next round in the interviewing/hiring process).

In some implementations described herein, to determine the recommendation, the virtual interview system may determine an interview (or hiring) score based on the response attributes and the historical interview data. An interview score that satisfies an interview score threshold may correspond to a positive recommendation (e.g., a recommendation to hire the candidate or to move the candidate on), whereas an interview score that fails to satisfy the interview score threshold may correspond to a negative recommendation (e.g., a recommendation to not hire the candidate or not to move the candidate on).

In some implementations described herein, the virtual interview system may determine the resume attributes and/or the response attributes via machine learning model(s). For example, the machine learning model(s) may use natural language processing (NLP) techniques to analyze the text in the candidate's resume and/or the verbal responses by the candidate in the video feed and/or audio feed. With respect to the response attributes, the machine learning model may be trained using the historical interview data.

In this way, the virtual interview system may be able to automatically generate a set of interview questions personalized to a particular candidate's experiences and/or qualifications beyond generic questions that are same to all candidates, and make a more accurate recommendation based on the response attributes identified from the candidate's responses (e.g., via the interview scoring system). In addition, the virtual interview system may have big data capability to handle thousands, millions, billions, or more combinations of resume attributes, to determine the set of interview questions, and combinations of response attributes to determine the recommendation (e.g., via the interview scoring system).

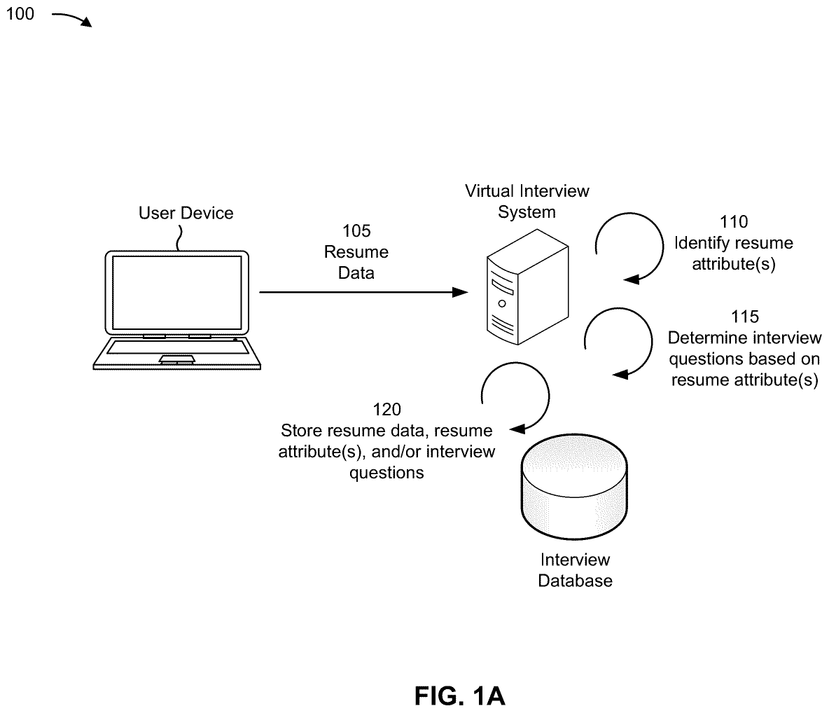

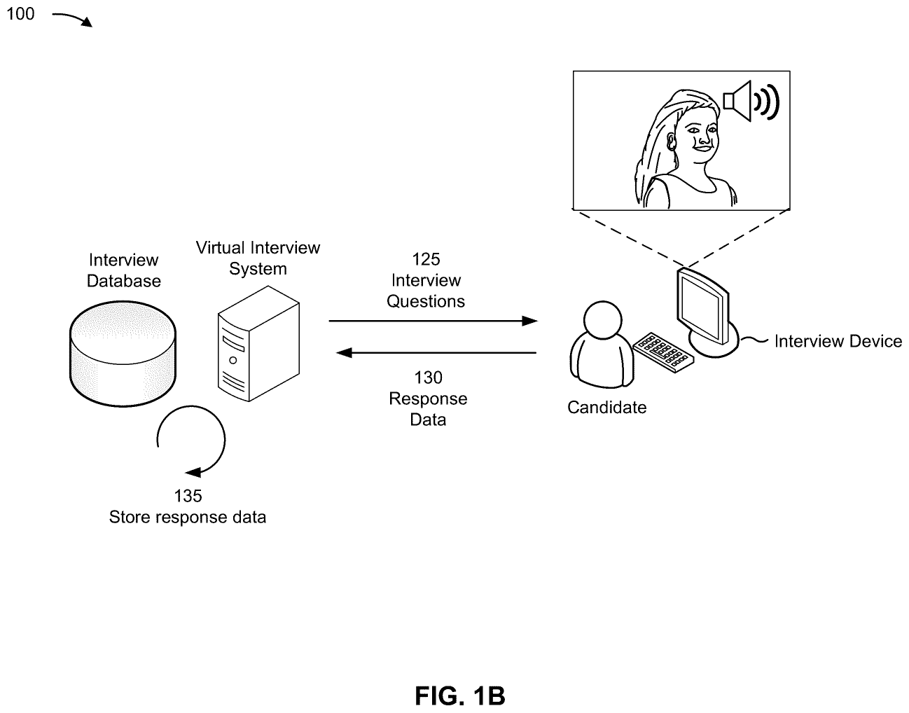

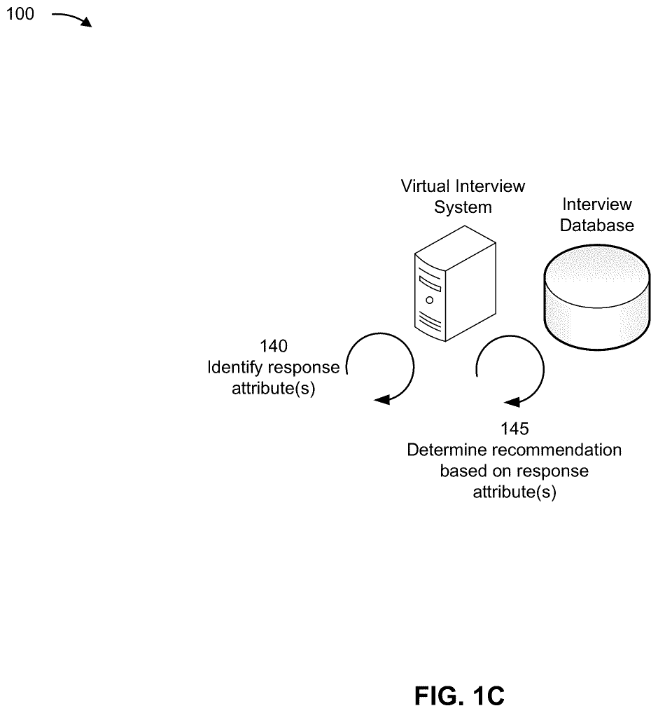

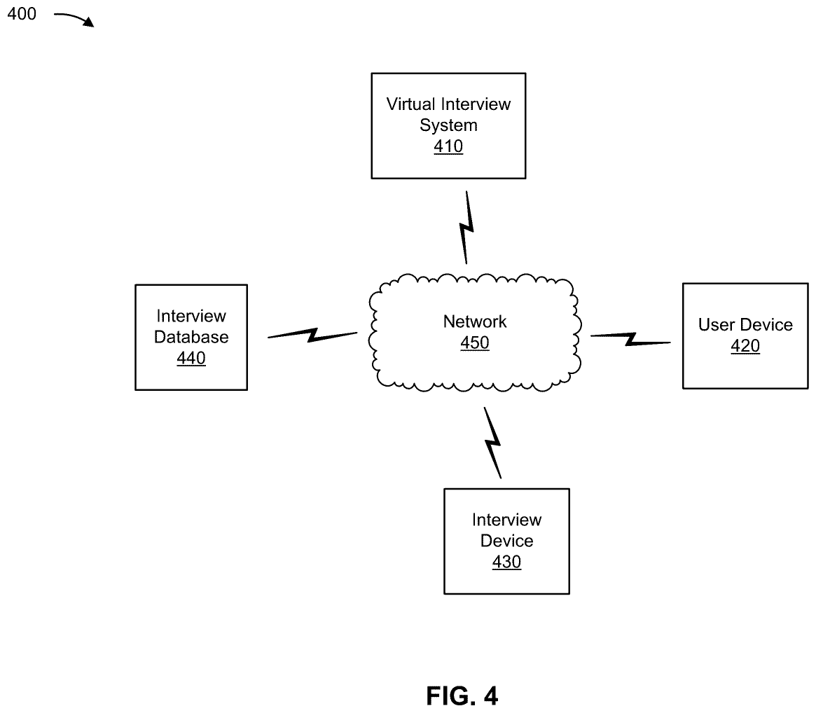

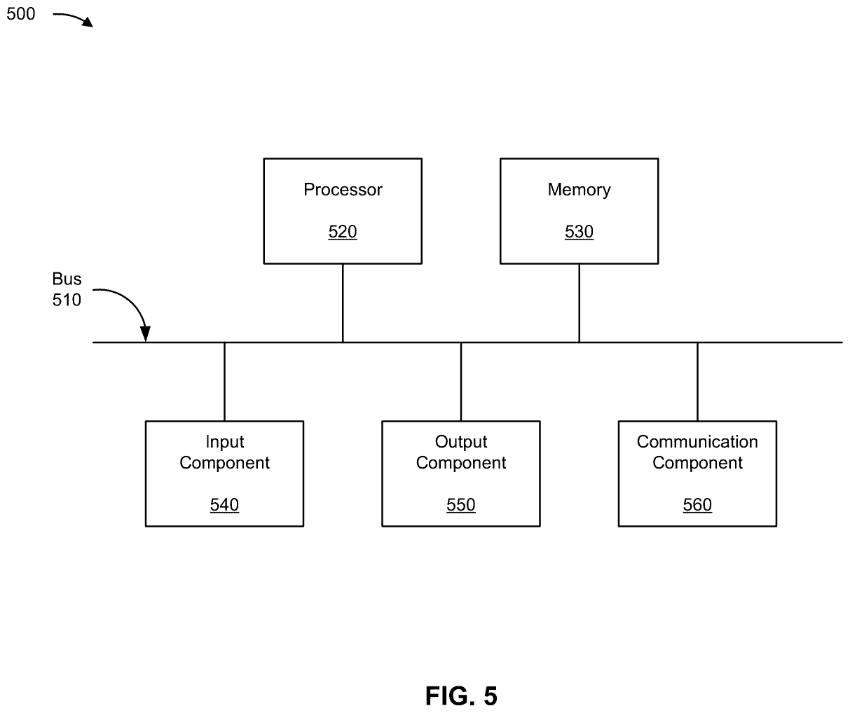

FIGS. 1A-1C are diagrams of an example 100 associated with a virtual interview system. As shown in FIGS. 1A-1C, example 100 includes a virtual interview system, a user device, an interview device, and an interview database. These devices are described in more detail in connection with FIGS. 4 and 5.

As shown in FIG. 1A, a user may be a candidate for a position of a particular entity (also referred to as an interviewing entity). For example, the user may be a candidate for a job of a hiring company, or the user may be a candidate for acceptance to a school. The user is also referred to herein as a candidate. The candidate may apply to the position via a user device. As part of the application process, the candidate may create, via the user device, a candidate account with the particular entity. The candidate account may include candidate information, such as the candidate's name, address, birth date, or the like. The candidate account also may include the position(s) (e.g., job(s)) to which the candidate may be applying.

The candidate also may be required to submit a resume of the candidate, which the candidate may perform via the user device (e.g., by manually entering resume information into designated entry fields presented on a display of the user device or by uploading a resume document). As shown by reference number 105, the user device may transmit, and the virtual interview system may receive, resume data corresponding to the resume.

As shown by reference number 110, the virtual interview system may identify, from the resume data, one or more resume attributes (e.g., a combination of multiple resume attributes) from a collection or library of different resume attribute options. A resume attribute may be information, in one or more resume categories, associated with the content of the resume and personal to the candidate. For example, such resume attributes and/or resume categories may include an education (e.g., a highest level of education, a degree, a major, a grade point average, and/or one or more schools), an experience level (e.g., a number of years of experience), a job history (e.g., employers, job titles, and/or job roles), one or more skill sets, awards or honors, volunteering experience, extracurricular activities, interests, or the like. Additionally, or alternatively, a resume attribute may be associated with the resume itself. For example, such resume attributes may include syntax (e.g., a number of syntax errors), grammar (e.g., a number of grammatical errors), and/or orthographic in nature (e.g., a number of orthographic errors), such as spelling.

A particular resume category may have a number (potentially an endless number) of resume attribute options. For example, a number of years of experience may range from 0 years of experience to over 50 years of experience. As another example, the resume attribute options may include an employer library (e.g., associated with a job history category in resumes) of any number of employers. Accordingly, combinations of resume attributes may number in the millions, billions, etc., and thus may present a big data problem. The virtual interview system may manage such a big data problem quickly and efficiently by processing the resume data to obtain a particular combination of resume attributes associated with a particular candidate, and subsequently identify a set of interview questions corresponding to the particular combination of resume attributes, as described below with respect to reference number 115.

In some implementations, the virtual interview system may use a machine learning model (also referred to as a first machine learning model) to identify the resume attribute(s). For example, the virtual interview system may provide the resume data as input to the first machine learning model. The virtual interview system may use a natural language processing (NLP) technique and/or algorithm to analyze the content of the resume data to identify the resume attribute(s).

As shown by reference number 115, the virtual interview system may determine a set of interview questions, based on the resume attribute(s), from a library of interview question options. For example, for a resume attribute of an engineering degree, an interview question may be to describe an engineering project on which the candidate participated. As another example, for a resume attribute of an English major, an interview question may be to describe a particular thesis paper that the candidate wrote. As another example, for a resume attribute indicating a former job that lasted less than a duration threshold (e.g., a year), a question may be to explain why the candidate stayed at the job for less than the duration threshold. The virtual interview system may have an interview question database (e.g., internal to the virtual interview system and/or accessible by the virtual interview system) of interview questions. Each interview question may correspond to one or more resume attributes. Accordingly, the virtual interview system may be able to form a set of interview questions to ask the candidate during a virtual interview. In implementations in which a machine learning model (e.g., the first machine learning model) may be used to determine the resume attribute(s), the virtual interview system may receive, as output from the machine learning model, the interview questions (or a list of question numbers corresponding to the interview questions).

In some implementations, based on the particular resume attribute(s), the virtual interview system may assign a particular candidate profile. The virtual interview system may have multiple candidate profiles, formed from combinations of different resume attributes, from which to select and assign a particular candidate profile to the candidate. Each candidate profile may be associated with a corresponding set of interview questions. Accordingly, when the virtual interview system assigns a candidate profile to the candidate, the virtual interview system may determine the interview questions based on the association with the candidate profile.

As shown by reference number 120, the virtual interview system may store the resume data, the resume attribute(s), and/or the interview questions (collectively referred to as the stored data), such as in an interview database. The stored data may be stored under the candidate account associated with the candidate. The virtual interview system may access the stored data (e.g., the interview questions) at a later time, such as for the virtual interview at such a later time.

As shown in FIG. 1B, the virtual interview system may conduct, via an interview device, the virtual interview with the candidate. The day and time of the virtual interview may have been scheduled, for example, when the candidate initially applied to the position and/or set up the candidate account. Alternatively, the virtual interview may be arranged such that the candidate may initiate the virtual interview at any time convenient for the candidate. In such a scenario, the virtual interview may have an expiration date by which the candidate may have to complete the virtual interview. The candidate may initiate the virtual interview, for example, by entering, in the interview device, one or more candidate credentials (e.g., a candidate identifier, a position identifier, and/or a code corresponding to the particular interview job, which may have been provided to the candidate when applying for the position) by which the candidate account may be accessed.

The interview device may be any device via which the candidate may participate in the virtual interview. The interview device may have a screen via which information may be displayed and/or via which the user may interact to provide and/or select information (e.g., candidate credentials to access the candidate's candidate account). The interview device may have one or more speakers via which an audio feed of the questions may be played. Additionally, or alternatively, the interview device may include a headphone port or a wireless connection (e.g., Bluetooth) via which headphones or a headset may be connected to the interview device. The interview device also may have a camera via which a video feed of the candidate responding to the questions may be taken, and/or a microphone via which an audio feed of the candidate responding.

In some implementations, the interview device may be a kiosk device. As an example, a kiosk device may be a standalone structure (e.g., a booth or a stand) in which components of the interview device (e.g., the screen, speaker(s), camera, and/or microphone) may be incorporated and in or at which the candidate may participate in the virtual interview. The kiosk device may be located at any geographic location. For example, the kiosk device may have a geographic location associated with the interviewing entity (e.g., an office of the interviewing entity). Having the kiosk device at the interviewing entity, thereby requiring the candidate to travel to the office of the interviewing entity, may provide the candidate with a more traditional and formal interview process. Additionally, or alternatively, the interview device may be a user device of the candidate.

As shown by reference number 125, after the candidate has initiated the virtual interview, the virtual interview system may transmit the interview questions to the interview device. The interview questions may be transmitted to the interview device one interview question at a time. The interview questions may be in the form of an audio feed, which may be played by the interview device (e.g., via speaker(s) of the interview device), and/or in the form of text (e.g., displayed on a screen of the interview device). The candidate may respond to each interview question before a subsequent interview question is transmitted to and presented by the interview device. Alternatively, multiple of the interview questions (e.g., all of the interview questions) may be transmitted together to the interview device. The interview device may be configured to present each interview question one at a time, where, after the first interview question is presented, each subsequent interview question may be presented after a response to a preceding interview question has been provided by the candidate. In either scenario, the virtual interview system and/or the interview device may determine that a response to a particular interview question is complete based on a condition. For example, if no audio is detected by the interview device for a threshold amount of time (e.g., 5 seconds or 10 seconds), then the virtual interview system and/or the interview device may determine that the response is complete, and may transmit and/or present the subsequent interview question. Additionally, or alternatively, the candidate may provide, via the interview device, an input indicating that the response is complete (e.g., by selecting an option to proceed to the next interview question presented on the interview device).

As the candidate provides the response for a particular interview question, the interview device may be recording a video feed and/or an audio feed of the response. As shown by reference number 130, the interview device may transmit, and the virtual interview system may receive, response data (e.g., video data indicating the video feed and/or audio data indicating the audio feed) corresponding to the response by the candidate. In some implementations, the interview device may transmit the response data in real-time while the virtual interview is ongoing (e.g., the interview device may stream the virtual interview to the virtual interview system). Additionally, or alternatively, the interview device may record the virtual interview and store the entire virtual interview (e.g., temporarily on a memory of the interview device). The interview device may then transmit the entire virtual interview (e.g., as response data) to the virtual interview system.

As shown by reference number 135, the virtual interview system may store the response data. For example, the virtual interview system may store the response data in the interview database and under the candidate account.

As shown in FIG. 1C, and by reference number 140, the virtual interview system may identify, from the response data, one or more response attributes (e.g., a combination of multiple response attributes) from data collection or library of different response attribute options. A response attribute may be information, in one or more response categories, associated with the content and/or substance of the responses by the candidate. For example, such response attributes and/or response categories may include syntax (e.g., a number of syntax errors), grammar (e.g., a number of grammatical errors), and/or a number of key words or phrases in the responses. In some implementations, the virtual interview system may process the video feed and/or the audio feed associated with the candidate's responses using a speech recognition model and/or a natural language processing model. Additionally, or alternatively, the virtual interview system may apply a language model (e.g., a neural language model) to the recognized speech to identify any syntax errors, grammatical errors, and/or key words that the language model and/or the virtual interview system may be trained to identify. The virtual interview system may maintain a count (e.g., via a counter) of the number of instances of response attributes in each response category, which the virtual interview system may use to determine a recommendation (e.g., via an interview score), as described in more detail below in connection with reference number 145.

Additionally, or alternatively, a response attribute may be associated with behavioral characteristics of the candidate during the virtual interview (e.g., when listening to the interview questions and/or when providing the responses). For example, such response attributes may include, speech speed, a percentage of eye contact, a time delay after the question to respond, speech inflection, tone fluctuation, eye movement, body movement, and/or facial expressions.

A response category may have a number (potentially an endless number) of response attribute options. For example, a candidate may have any number of syntax and/or grammatical errors in the candidate's responses. As another example, a percentage of eye contact could range from 0% to 100%. As another example, the response attribute options may include various types of body language, facial expressions, or the like. Accordingly, combinations of response attributes may number in the millions, billions, etc., and thus may present a big data problem (e.g., in addition to the big data problem associated with the resume attributes). The virtual interview system may manage such a big data problem quickly and efficiently by processing the response data to obtain a particular combination of response attributes associated with a particular candidate, and subsequently determining a recommendation associated with the particular candidate, as described below with respect to reference number 145.

In some implementations, the virtual interview system may use a machine learning model (also referred to as a second machine learning model) to identify the response attribute(s). For example, the virtual interview system may provide the response data as input to the second machine learning model. The virtual interview system may use a natural language processing (NLP) technique and/or algorithm to analyze the content of the response data to identify at least the response attribute(s) associated with the content and/or substance of the responses.

As shown by reference number 145, the virtual interview system may determine a recommendation based on the response attribute(s). The recommendation may be to hire or not hire a candidate (e.g., a hiring recommendation), to accept or not accept the candidate, or to advance the candidate to a next round in the interview process (e.g., an in-person interview). In some implementations, to determine the recommendation, the virtual interview system may determine an interview score (also referred to as a hiring score for a job application scenario) based on the response attribute(s). Each response attribute may be assigned an attribute score, and the interview score may be a sum of the attribute scores or an average of the attribute scores. The attribute scores may be on a set scale (e.g., 1-10 or 1-100). As an example, for a response attribute associated with syntax and/or grammar, no errors in syntax and/or grammar may correspond to a highest attribute score (e.g., 10). The attribute score may decrease as the number of errors increases up to an error number threshold (e.g., 10 errors), at or beyond which the corresponding attribute score may be the lowest (e.g., 0). Alternatively, a set attribute score may be assigned for different ranges of number of errors (e.g., 0-1 errors may correspond to an attribute score of 10, 2-3 may correspond to an attribute score of 9, etc.). As another example, for a response attribute of speech speed, the attribute score may decrease as the speech speed deviates (above or below) from a speech speed value (e.g., 2.5 words per minute). As another example, for a response attribute of a percentage of eye contact (e.g., with the camera of the interview device), complete eye contact (e.g., 100%) may correspond to a highest attribute score (e.g., 10). The attribute score may decrease as the percentage decreases to a percentage threshold (e.g., 10 errors), at or beyond which the corresponding attribute score may be the lowest (e.g., 0). Alternatively, a set attribute score may be assigned for different ranges of percentages (e.g., 90%-100% may correspond to an attribute score of 10, 80%-89% may correspond to an attribute score of 9, etc.).

In some implementations, the virtual interview system may determine attribute scores corresponding to response attributes associated with each response to a corresponding interview question. The virtual interview system may then determine response scores corresponding to the responses (e.g., each response may have a corresponding response score), such as by summing or averaging the attribute scores. The virtual interview system may then determine the interview score based on the response scores (e.g., by summing or averaging the response scores).

In some implementations, different response attributes or categories of response attributes may have different weights in determining the interview score. For example, response attributes associated with behavioral characteristics may have a higher weight than response attributes associated with content. The weights may be adjustable and may be based on a preference set by the interviewing entity.

The virtual interview system may determine the recommendation based on the interview score. For example, if the interview score satisfies (e.g., meets or exceeds) an interview score threshold (e.g., 8), then the virtual system may determine a positive recommendation (e.g., to hire the candidate or to advance the candidate). Alternatively, if the interview score fails to satisfy (e.g., falls below) the interview score threshold, then the virtual interview system may determine a negative recommendation (e.g., not to hire or advance the candidate).

In implementations in which a machine learning model (e.g., the first machine learning model) may be used to determine the resume attribute(s), the virtual interview system may receive, as output from the machine learning model the recommendation or the interview score. The second machine learning model may be trained based on historical response data associated with historical interviews by historical candidates. Additionally, in scenarios in which historical candidates were hired (also referred to as hired candidates), the second machine learning model may be re-trained based on performance data associated with performances of the hired candidates. If the performance of a particular hired candidate is positive, then the second machine learning model may be re-trained to assign similar attribute scores and/or interview score, for a future candidate, corresponding to the response attributes (or combination of response attributes) associated with the hired candidate's virtual interview, or may modify the attribute scores and/or interview score upwards (e.g., a higher score). In contrast, if the performance of a particular hired candidate is negative, then the second learning model may be re-trained to assign lower attribute scores and/or interview score (e.g., below a score threshold). The amount that the score(s) may be adjusted up or down may depend on the performance (e.g., amount of success or lack of success of the particular candidate).

The performances of hired candidates may be based on one or more factors. In some implementations, a factor for a particular candidate may include a length of employment. For example, if a hired candidate was employed for a short time (e.g., less than a duration threshold) or for a long time (e.g., more than a duration threshold), then the trained machine learning model 325 may adjust future recommendations and/or interview scores associated with a future candidate having similar response attributes (or interview profile). Additionally, or alternatively, another factor may include one or more achievement indicators associated with the particular candidate and/or one or more fault indicators associated with the particular candidate. An achievement indicator may be a positive indicator of success associated with the hired candidate. For example, an achievement indicator may include a promotion, a recognition, an award, a raise, and/or a positive evaluation or review. A fault indicator may be a negative indicator of success (or a positive indicator of fault) associated with the hired candidate. For example, a fault indicator may include a negative evaluation or review, a human resources write-up, and/or a pay cut.

As described above, the virtual interview system may enable a candidate to virtually interview via an interview device. The interview device may present interview questions to the candidate and may receive real-time responses from the candidate (in the form of a video feed and/or an audio feed). The interview questions may be determined based on resume attributes (e.g., syntax, grammar, education, skills, experience, job history, and/or job roles) derived from the candidate's resume, which may be received prior to the virtual interview. Based on the real-time responses, the virtual interview system may determine response attributes (e.g., syntax, grammar, and/or behavioral characteristics, such as body language, talking speed, and/or eye contact) associated with the candidate. Based on the response attributes and historical interview data associated with the same or similar response attributes, the virtual interview system may determine a recommendation with respect to the candidate (e.g., whether or not to hire the candidate or move the candidate on to a next round in the interviewing/hiring process).

In this way, the virtual interview system may be able to automatically generate a set of interview questions personalized to a particular candidate's experiences and/or qualifications beyond generic questions same to all candidates, and make a more accurate recommendation based on the response attributes identified from the candidate's responses (e.g., via the interview scoring system). In addition, the virtual interview system may have big data capability to handle thousands, millions, billions, or more combinations of resume attributes, to determine the set of interview questions, and combinations of response attributes to determine the recommendation (e.g., via the interview scoring system). In this way, the virtual interview system may be able to provide an objective analysis of a candidate (e.g., without biases and/or prejudices) in determining whether or not that candidate should be hired or moved on to a next round in the interview process. As a result, the candidates best suited for the interviewing entity (e.g., meeting the particular interviewing entity's needs) may be considered and not overlooked, thereby making the interview process more efficient and effective for the interviewing entity. Accordingly, the virtual interview system may conserve system resources (e.g., computing resources and/or network resources) that may otherwise be expended interviewing and/or hiring candidates that do not meet the interviewing entity's needs.

As indicated above, FIGS. 1A-1C are provided as an example. Other examples may differ from what is described with regard to FIGS. 1A-1C.

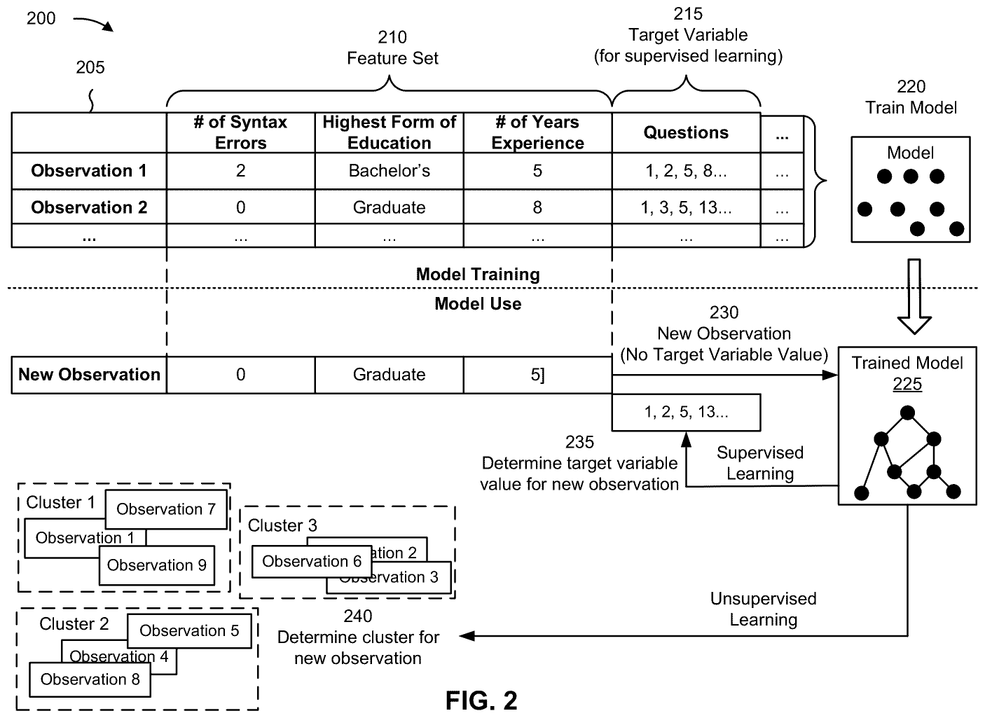

FIG. 2 is a diagram illustrating an example 200 of training and using a machine learning model in connection with a virtual interview system. The machine learning model training and usage described herein may be performed using a machine learning system. The machine learning system may include or may be included in a computing device, a server, a cloud computing environment, or the like, such as the virtual interview system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the virtual interview system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input (e.g., resume data) received from the virtual interview system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of number of syntax errors, a second feature of highest form of education, a third feature of number of years of experience, and so on. As shown, for a first observation, the first feature may have a value of 0, the second feature may have a value of “Bachelor's,” the third feature may have a value of 5, and so on. These features and feature values are provided as examples, and may differ in other examples. For example, the feature set may include one or more of the following features: number of orthographic errors (e.g., spelling errors), number of grammatical errors, job history, job responsibilities, skill set(s), honors and/or awards, memberships, languages, or interests.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a list of interview questions, which has a value of 1, 2, 5, 8, . . . (each corresponding to a specific interview question) for the first observation.

The feature set and target variable described above are provided as examples, and other examples may differ from what is described above. For example, an alternative target variable may be an interview candidate profile or type, which may be associated with a set of interview questions. The target variable for the feature set may be Type A, which may be associated with questions 1, 2, 5, 8, etc.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a natural language processing (NLP) algorithm, a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As an example, the machine learning system may obtain training data for the set of observations based on historical resumes and corresponding historical interviews associated with historical candidates.

As shown by reference number 230, the machine learning system may apply the trained machine learning model 225 to a new observation, such as by receiving a new observation and inputting the new observation to the trained machine learning model 225. As shown, the new observation may include a first feature of number of syntax errors, a second feature of highest form of education, a third feature of numbers of years of experience, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 1, 2, 5, 13 . . . for the target variable of Questions for the new observation, as shown by reference number 235. Based on this prediction, the machine learning system may perform a first automated action and/or may cause a first automated action to be performed (e.g., by instructing another device to perform the automated action), among other examples. The first automated action may include, for example, transmit the questions to the interview device.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., same level of education), then the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., same number (or range) of years of experience), then the machine learning system may perform or cause performance of a second (e.g., different) automated action, such as transmitting a different set of questions to the interview device.

In some implementations, the automated action associated with the new observation may be based on a target variable value having a particular label (e.g., classification or categorization) and/or may be based on a cluster in which the new observation is classified.

The actions and clusters described above are provided as examples, and other examples may differ from what is described above. For example, the actions may include, for example, storing the questions under a profile associated with the candidate for a future interview (e.g., at a different time than when the resume data was received). The clusters may include, for example, the same schools, the same former employers, the same major, one or more of the same skill sets, or the like.

In some implementations, the trained machine learning model 225 may be re-trained using feedback information. For example, feedback may be provided to the machine learning model. The feedback may be associated with actions performed based on the automated actions performed, or caused, by the trained machine learning model 225. In other words, the actions output by the trained machine learning model 225 may be used as inputs to re-train the machine learning model (e.g., a feedback loop may be used to train and/or update the machine learning model). For example, the feedback information may include a low average attribute score (e.g., below a score threshold, such as 3), across multiple candidates, associated with a particular interview question. Additionally, or alternatively, an administrator associated with the interviewing entity may remove a particular interview question from the set of interview questions for a particular candidate.

In this way, the machine learning system may apply a rigorous and automated process to determine a set of interview questions for a particular candidate. The machine learning system enables recognition and/or identification of tens, hundreds, thousands, or millions of features and/or feature values for tens, hundreds, thousands, or millions of observations, thereby increasing accuracy and consistency and reducing delay associated with determining a set of interview questions for a particular candidate relative to requiring computing resources to be allocated for tens, hundreds, or thousands of operators to manually determine a set of interview questions for a particular candidate using the features or feature values.

As indicated above, FIG. 2 is provided as an example. Other examples may differ from what is described in connection with FIG. 2.

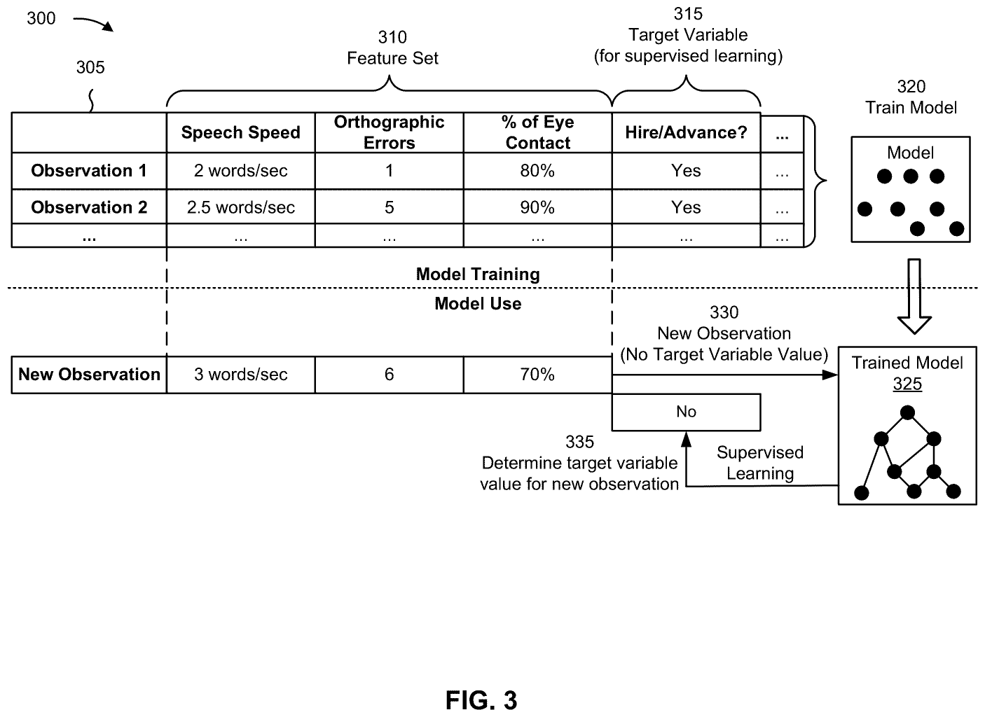

FIG. 3 is a diagram illustrating an example 300 of training and using a machine learning model in connection with a virtual interview system. The machine learning model training and usage described herein may be performed using a machine learning system. The machine learning system may include or may be included in a computing device, a server, a cloud computing environment, or the like, such as the virtual interview system described in more detail elsewhere herein.

As shown by reference number 305, a machine learning model may be trained using a set of observations. The set of observations may be obtained from training data (e.g., historical data), such as data gathered during one or more processes described herein. In some implementations, the machine learning system may receive the set of observations (e.g., as input) from the virtual interview system, as described elsewhere herein.

As shown by reference number 310, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input (e.g., response attributes) received from the virtual interview system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of speech speed, a second feature of number of orthographic errors, a third feature of percentage of eye contact, and so on. As shown, for a first observation, the first feature may have a value of 2 words per minute, the second feature may have a value of 1, the third feature may have a value of 80%, and so on. These features and feature values are provided as examples, and may differ in other examples. For example, the feature set may include one or more of the following features: number of syntax errors, a time delay after the question to respond, speech inflection, tone fluctuation, eye movement, body movement, and/or facial expressions.

As shown by reference number 315, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 300, the target variable is whether or not to hire/advance the candidate, which has a value of Yes for the first observation.

The feature set and target variable described above are provided as examples, and other examples may differ from what is described above. For example, a target variable may be an interview score (or a hiring score), on which the recommendation may be based. If the interview score satisfies (e.g., is greater than or equal to) an interview score threshold, then the recommendation may be to hire or advance the candidate. If the interview score fails to satisfy (e.g., is less than) the interview score threshold, then the recommendation may be to not hire or not advance the candidate. The target variable for the feature set may have a value of 8.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 320, the machine learning system may train a machine learning model using the set of observations and using one or more machine learning algorithms, such as an NLP algorithm, a regression algorithm, a decision tree algorithm, a neural network algorithm, a k-nearest neighbor algorithm, a support vector machine algorithm, or the like. After training, the machine learning system may store the machine learning model as a trained machine learning model 325 to be used to analyze new observations.

As an example, the machine learning system may obtain training data for the set of observations based on historical responses in corresponding historical interviews associated with historical candidates.

As shown by reference number 330, the machine learning system may apply the trained machine learning model 325 to a new observation, such as by receiving a new observation and inputting the new observation to the trained machine learning model 325. As shown, the new observation may include a first feature of speech speed, a second feature of number of orthographic errors, a third feature of percentage of eye contact, and so on, as an example. The machine learning system may apply the trained machine learning model 325 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 325 may predict a value of No for the target variable of whether or not to hire or advance the candidate for the new observation, as shown by reference number 335. Based on this prediction, the machine learning system may provide a first recommendation, may provide output for determination of a first recommendation, among other examples. The first recommendation may include, for example, not to hire or advance the candidate. The target variable for the feature set may have a value of No.

In some implementations, the recommendation associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like).

In some implementations, the trained machine learning model 325 may be re-trained using feedback information. For example, feedback may be provided to the machine learning model. As an example, the feedback information may include performance data associated with performances of candidates that were recommended to be hired or advanced in the interview process (e.g., hired candidates). The performances may be based on one or more factors. In some implementations, a factor for a particular candidate may include a length of employment. For example, if a hired candidate was employed for a short time (e.g., less than a duration threshold) or for a long time (e.g., more than a duration threshold), then the trained machine learning model 325 may adjust future recommendations and/or interview scores associated with a future candidate having similar response attributes (or interview profile). Additionally, or alternatively, another factor may include one or more achievement indicators (e.g., a promotion, a recognition, an award, a raise, and/or a positive evaluation or review) associated with the particular candidate and/or one or more fault indicators (e.g., a negative evaluation or review, a human resources write-up, and/or a pay cut) associated with the particular candidate.

In this way, the machine learning system may apply a rigorous and automated process to determine a recommendation associated with a candidate. The machine learning system enables recognition and/or identification of tens, hundreds, thousands, or millions of features and/or feature values for tens, hundreds, thousands, or millions of observations, thereby increasing accuracy and consistency and reducing delay associated with determining a recommendation associated with a candidate relative to requiring computing resources to be allocated for tens, hundreds, or thousands of operators to manually determine a recommendation associated with a candidate using the features or feature values.

As indicated above, FIG. 3 is provided as an example. Other examples may differ from what is described in connection with FIG. 3.

FIG. 4 is a diagram of an example environment 400 in which systems and/or methods described herein may be implemented. As shown in FIG. 4, environment 400 may include a virtual interview system 410, a user device 420, an interview device 430, an interview database 440, and a network 450. Devices of environment 400 may interconnect via wired connections, wireless connections, or a combination of wired and wireless connections.

The virtual interview system 410 may include one or more devices capable of receiving, generating, storing, processing, providing, and/or routing information associated with a virtual interview system, as described elsewhere herein. The virtual interview system 410 may include a communication device and/or a computing device. For example, the virtual interview system 410 may include a server, such as an application server, a client server, a web server, a database server, a host server, a proxy server, a virtual server (e.g., executing on computing hardware), or a server in a cloud computing system. In some implementations, the virtual interview system 410 includes computing hardware used in a cloud computing environment.

The user device 420 may include one or more devices capable of receiving, generating, storing, processing, and/or providing information associated with a virtual interview system, as described elsewhere herein. The user device 420 may include a communication device and/or a computing device. For example, the user device 420 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The interview device 430 may include one or more devices capable of receiving, generating, storing, processing, and/or providing information associated with a virtual interview system, as described elsewhere herein. The interview device 430 may include a communication device and/or a computing device. For example, the interview device 430 may include a kiosk, wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The interview database 440 may include one or more devices capable of receiving, generating, storing, processing, and/or providing information associated with a virtual interview system, as described elsewhere herein. The interview database 440 may include a communication device and/or a computing device. For example, the interview database 440 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the interview database 440 may store candidate profiles associated with different candidates and for each candidate profile, resume data corresponding to a resume of a particular candidate, resume attributes determined from the resume data, interview questions determined based on the resume attributes, response data (e.g., a video feed and/or an audio feed) corresponding to responses to interview questions, response attributes determined from the response data, an interview score determined based on the response data, a recommendation, and/or performance data associated with performances of candidates who advanced (e.g., were hired), as described elsewhere herein.

The network 450 may include one or more wired and/or wireless networks. For example, the network 450 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 450 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

FIG. 5 is a diagram of example components of a device 500 associated with a virtual interview system. The device 500 may correspond to the virtual interview system 410, the user device 420, the interview device 430, and/or the interview database 440. In some implementations, the virtual interview system 410, the user device 420, the interview device 430, and/or the interview database 440 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

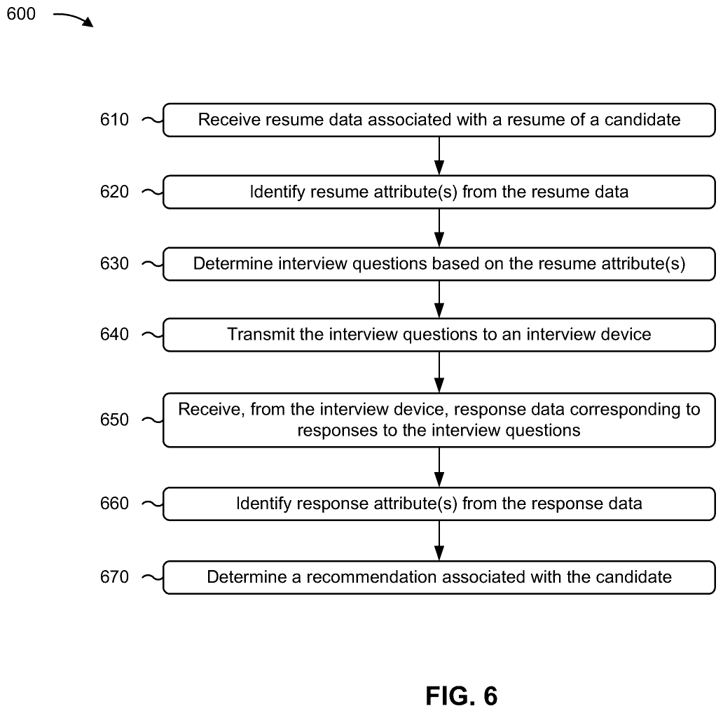

FIG. 6 is a flowchart of an example process 600 associated with a virtual interview system. In some implementations, one or more process blocks of FIG. 6 may be performed by the virtual interview system 410. In some implementations, one or more process blocks of FIG. 6 may be performed by another device or a group of devices separate from or including the virtual interview system 410, such as the interview device 430. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving resume data associated with a resume of a candidate (block 610). For example, the virtual interview system 410 (e.g., using processor 520, memory 530, input component 540, and/or communication component 560) may receive resume data associated with a resume of a candidate, as described above in connection with reference number 105 of FIG. 1A.

As further shown in FIG. 6, process 600 may include identifying resume attribute(s) from the resume data (block 620). For example, the virtual interview system 410 (e.g., using processor 520 and/or memory 530) may identify, from the resume data, one or more resume attributes, as described above in connection with reference number 110 of FIG. 1A.

As further shown in FIG. 6, process 600 may include determining interview questions based on the resume attribute(s) (block 630). For example, the virtual interview system 410 (e.g., using processor 520 and/or memory 530) may determine, based on the one or more resume attributes, a plurality of interview questions, as described above in connection with reference number 115 of FIG. 1A.

As further shown in FIG. 6, process 600 may include transmitting the interview questions to an interview device (block 640). For example, the virtual interview system 410 (e.g., using processor 520, memory 530, and/or communication component 560) may transmit, to an interview device, the plurality of interview questions, wherein an interview question, of the plurality of interview questions and after a first interview question of the plurality of interview questions, may be transmitted after receiving a response to a preceding interview question of the plurality of interview questions, as described above in connection with reference number 120 of FIG. 1B.

As further shown in FIG. 6, process 600 may include receiving, from the interview device, response data corresponding to responses to the interview questions (block 650). For example, the virtual interview system 410 (e.g., using processor 520, memory 530, input component 540, and/or communication component 560) may receive, from the interview device, response data corresponding to a plurality of responses to the plurality of interview questions, wherein, for a particular response of the plurality of responses, the response data may include a video feed, from the interview device, of the candidate providing the particular response, as described above in connection with reference number 130 of FIG. 1B.

As further shown in FIG. 6, process 600 may include identifying response attribute(s) from the response data (block 660). For example, the virtual interview system 410 (e.g., using processor 520 and/or memory 530) may identify, from the response data, one or more response attributes, as described above in connection with reference number 140 of FIG. 1C.

As further shown in FIG. 6, process 600 may include determining a recommendation associated with the candidate (block 670). For example, the virtual interview system 410 (e.g., using processor 520 and/or memory 530) may determine, based on the one or more response attributes and based on historical response data associated with historical responses, a recommendation associated with the candidate, as described above in connection with reference number 145 of FIG. 1C.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1C. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for providing a virtual interview using machine learning models, the system comprising:
one or more memories; and
one or more processors, communicatively coupled to the one or more memories, configured to:
receive, from a user device of a user, resume data corresponding to a resume of the user;
provide the resume data as input to a first machine learning model,
wherein the first machine learning model uses a natural language processing (NLP) technique to identify a combination of resume attributes, from a plurality of resume attribute options, associated with the resume data;
receive, as output from the first machine learning model, a set of interview questions, from a plurality of interview question options, associated with the combination of resume attributes;
transmit, to a kiosk device, a first question of the set of interview questions;
receive, from the kiosk device, response data corresponding to a response to the first question;
transmit, to the kiosk device and based on receiving response data corresponding to a response to a previous question of the set of interview questions, a subsequent question of the set of interview questions;
receive, from the kiosk device, response data corresponding to a response to the subsequent question,
wherein, for a particular response, the response data includes a video feed, from the kiosk device, of the user providing the particular response;
provide the response data as input to a second machine learning model, wherein the second machine learning model identifies a combination of response attributes, from a plurality of response attribute options, associated with the response data, and
wherein the second machine learning model is trained based on historical response data associated with historical responses;
receive, as output from the machine learning model, a hiring score corresponding to the combination of response attributes; and
determine, based on the hiring score, a hiring recommendation,
wherein a positive hiring recommendation corresponds to a hiring score that satisfies a hiring score threshold, and a negative hiring recommendation corresponds to a hiring score that fails to satisfy the hiring score threshold.

2. The system of claim 1, wherein the second machine learning model is re-trained based on performance data associated with performances of hired candidates, and
wherein the performances are based on one or more factors.

3. The system of claim 2, wherein the one or more factors, for a particular hired candidate of the hired candidates, includes a length of employment associated with the particular hired candidate.

4. The system of claim 2, wherein the one or more factors, for a particular hired candidate of the hired candidates, includes at least one of:
one or more achievement indicators associated with the particular hired candidate, or
one or more fault indicators associated with the particular hired candidate.

5. The system of claim 1, wherein a resume attribute, from the combination of resume attributes, is associated with syntax.

6. The system of claim 1, wherein a resume attribute, from the combination of resume attributes, identifies an education associated with the user.

7. The system of claim 1, wherein a resume attribute, from the combination of resume attributes, identifies an experience level associated with the user.

8. The system of claim 1, wherein a resume attribute, from the combination of resume attributes, identifies a job history associated with the user.

9. The system of claim 1, wherein a resume attribute, from the combination of resume attributes, identifies one or more skill sets associated with the user.

10. A method of providing a virtual interview, comprising:
receiving, by a system having one or more processors, resume data associated with a resume of a candidate;
identifying, by the system and from the resume data, one or more resume attributes;
determining, by the system and based on the one or more resume attributes, a plurality of interview questions;
transmitting, by the system and to an interview device, the plurality of interview questions,
wherein an interview question, of the plurality of interview questions, is transmitted after receiving a response to a preceding interview question of the plurality of interview questions;
receiving, by the system and from the interview device, response data corresponding to a plurality of responses to the plurality of interview questions,
wherein, for a particular response of the plurality of responses, the response data includes a video feed, from the interview device, of the candidate providing the particular response;
identifying, by the system and from the response data, one or more response attributes; and
determining, by the system and based on the one or more response attributes and based on historical response data associated with historical responses, a recommendation associated with the candidate.

11. The method of claim 10, wherein determining the recommendation comprises:
determining an interview score,
wherein a positive recommendation corresponds to an interview score that satisfies an interview score threshold, and a negative recommendation corresponds to an interview score that fails to satisfy the interview score threshold.

12. The method of claim 10, wherein the one or more resume attributes includes at least one of:
syntax,
an education associated with the candidate,
an experience level associated with the candidate,
a job history associated with the candidate, or
one or more skill sets associated with the candidate.

13. The method of claim 10, wherein the one or more response attributes identifies at least one of:
syntax,
grammar,
tone fluctuation, or
speech speed.

14. The method of claim 10, wherein the one or more response attributes identifies at least one of:
eye contact of the candidate with a camera of the interview device,
eye movement of the candidate,
facial expressions of the candidate, or
body movement of the candidate.

15. A non-transitory computer-readable medium storing a set of instructions, the set of instructions comprising:
one or more instructions that, when executed by one or more processors of a device, cause the device to:
receive, from a user device of a user, resume data corresponding to a resume of the user;
identify, from the resume data, one or more resume attributes;
determine, based on the one or more resume attributes, a plurality of interview questions;
transmit, to an interview device, the plurality of interview questions,
wherein an interview question, of the plurality of interview questions, is transmitted after receiving a response to a preceding interview question of the plurality of interview questions;
receive, from the interview device, response data corresponding to a plurality of responses to the plurality of interview questions,
wherein, for a particular response of the plurality of responses, the response data includes a video feed from the interview device of the user providing the particular response;
receive, from the interview device, response data corresponding to a plurality of responses to the plurality of interview questions,
wherein, for a particular response of the plurality of responses, the response data includes a video feed, from the interview device, of the user providing the particular response;
identify, from the response data, one or more response attributes;
determine, based on the one or more response attributes, an interview score; and
determine, based on the interview score, a recommendation associated with the user,
wherein a positive recommendation corresponds to an interview score that satisfies an interview score threshold, and a negative recommendation corresponds to an interview score that fails to satisfy the interview score threshold.

16. The non-transitory computer-readable medium of claim 15, wherein the one or more instructions, that cause the device to determine the plurality of interview questions, cause the device to:
provide the resume data as input to a machine learning model, which uses a natural language processing (NLP) technique to identify the one or more resume attributes; and
receive the plurality of interview questions as output from the machine learning model.

17. The non-transitory computer-readable medium of claim 15, wherein the one or more instructions, that cause the device to determine the interview score, cause the device to:
provide the response data as input to a machine learning model, which uses a natural language processing (NLP) technique to identify the one or more response attributes; and
receive the interview score as output from the machine learning model.

18. The non-transitory computer-readable medium of claim 15, wherein at least a subset of the plurality of interview questions is transmitted as audio data.

19. The non-transitory computer-readable medium of claim 15, wherein the one or more resume attributes are based on at least one of:
audio data from the video feed, or
video data from the video feed.

20. The non-transitory computer-readable medium of claim 15, wherein the interview device is a kiosk having a geographic location associated with an interviewing entity.
